(19) United States
(12) Patent Application Publication
(10) Pub. No.: US 2007/0187547 A1
(43) Pub. Date: Aug. 16, 2007

(54) Vertical Lifting of Airplanes to Flying Heights

(76) Inventor: Patrick D. Kelly, Kirkwood, MO (US)

Correspondence Address: PATRICK D. KELLY, 11939 MANCHESTER #403, ST. LOUIS, MO, 63131, US

(21) Appl. No.: 11/557,378

(22) Filed: Nov. 7, 2006

Related U.S. Application Data
(63) Continuation-in-part of application No. 10/692,057, filed on Oct. 23, 2003, now Pat. No. 7,131,613.

(51) Int. Cl. B64C 27/22

(52) U.S. Cl. 244/7 R

(57) ABSTRACT

Lifting “ferries” having rotatable wings with propeller engines can lift airplanes vertically, during takeoffs, in a quieter and safer manner with reduced fuel consumption and carbon dioxide emissions. Four rotatable wings are used, to provide balanced lifting force, and to prevent downdraft or propwash from blowing directly against the wings of an airplane being lifted. An optional buoyant aircraft such as a zeppelin can also be used to provide lifting force. Such buoyant aircraft should have adjustable internal struts, to convert it into a streamlined shape for moderate-speed flight and descent. Alternately, a zeppelin can be provided directly with four large rotatable propeller engines, to create a single-unit buoyant lifting ferry.

### RELATED APPLICATION

This application is a continuation-in-part of utility application Ser. No. 10/692,057, filed Oct. 23, 2006, scheduled to issue on Nov. 7, 2006 as U.S. Pat. No. 7,131,613.

### BACKGROUND

This invention is in the field of airplanes, aeronautics, and fuel conservation, and relates to the use of aircraft with rotatable wings (and with optional buoyant aircraft, if desired), for fuel-efficient lifting of fixed-wing airplanes up to flying altitudes, before the airplanes are released for flight.

Increased fuel costs, which have risen sharply since 2001, have imposed major financial stresses on airlines around the world. Numerous airlines were forced to declare bankruptcy, and had to take drastic measures (including worrisome reductions in their maintenance budgets) to continue operating.

In addition, concerns over fuel consumption and carbon dioxide emissions increased notably beginning in 2005, due to events such as Hurricanes Katrina, Rita, and Wilma in the US, as well as alarming rates of loss of ice, snow, and glaciers in the Arctic, Greenland, Antarctica, and elsewhere.

As a third relevant factor, the aging of airplane fleets around the world raises serious concerns over their safety, and it must be recognized that one of the most stressful and dangerous portions of any flight occurs during takeoff. Therefore, if a method can be provided to make takeoffs gentler, easier, and less stressful on airplanes, and if methods can be provided for lifting airplanes above a cloud layer during a storm, it would help reduce and control various mechanical, aging, and safety concerns, as well as the risks of weather-related plane crashes.

In addition, airplane takeoffs as described herein would be much quieter than current takeoffs, which would benefit communities located near airports. Slow and gentle takeoffs also would be more enjoyable for most passengers, especially if the windows of an airplane are enlarged, to make the liftoff more of a scenic visual experience, in ways that can combine the advantages and enjoyment of a tourist flight with the enjoyment of a ride in a hot air balloon, blimp, or helicopter.

The only relevant prior art known to the inventor involves tests that were carried out by the U.S. Navy in the 1920's and 1930's, under the name “Skyhook”, involving small planes carried aloft by large blimps. By the late 1930's, the military realized that it would be too easy for enemy planes to shoot down a blimp; therefore, that project was dropped, and replaced by efforts to create bombers that were large enough to carry several small fighter planes, so that the fighter planes could save their fuel until they were needed to defend the bomber. Those efforts are described in aviation history sources such as http ://davidszondy.com/future/Flight/parasite.htm.

Another subject also requires attention herein, involving various terms (such as balloons, blimps, dirigibles, and zeppelins) used for buoyant aircraft.

Dirigible derives from the French word for directable, or steerable. This distinguishes dirigibles from hot air or helium balloons, which (in common usage) are not steerable, and instead are carried by winds. On a practical level, to render a dirigible controllable and steerable, it needs to be elongated and streamlined, it needs to have movable fins, and it needs some type of power (such as propeller engines) to enable steering.

Blimp refers to a dirigible that has a soft and flexible outer covering (which can also be called a skin, membrane, envelope, or similar terms). However, terms such as “soft and flexible” are not definite, and the transition zine between soft and stiff is blurred by various types of foils, films, and sheets having a range of thicknesses. Therefore, the term blimp tends to imply an outer covering that is sufficiently flexible to render the craft collapsible, for storage and ground transport. However, that definition is not used consistently, and any dirigible having a flexible outer membrane can be called a blimp. Since thin and lightweight films made of polymers can provide better performance than sheet metal or other known materials, any modern dirigible or zeppelin will have an outer membrane that is soft and flexible enough to allow the aircraft to be called a blimp.

Zeppelin originally described a design created by a specific person, Ferdinand Graf von Zeppelin; however, because of various reasons, it is not clear how similar to Zeppelin's designs a dirigible must be, to qualify for that name. As used today, zeppelin implies that the aircraft has multiple sealed internal compartments, to hold the gas. That is standard design, for both safety and economy, since it minimizes the loss of expensive helium if one or more compartments are breached, and it gives an aircraft a chance to descend slowly enough to avoid disaster, if a crisis occurs. Therefore, multiple sealed gas compartments are standard features in modem dirigibles.

In view of those factors, the terms dirigible, zeppelin, and blimp can be used interchangeably for buoyant aircraft that are elongated and steerable, that have multiple internal compartments for holding gas, and that have flexible outer membranes. Dirigible was the earlier French term, but the German term zeppelin later became dominant, partly because of improved designs, and partly because the Germans did more work with such aircraft than the French, in the early era of such craft. Dirigible is an awkward and dissonant word, while zeppelin is easier to say and has a more modem and appealing sound, as evidenced by the band Led Zeppelin (whose song “Stairway to Heaven”, or some derivative thereof, may become an anthem for this invention). Based on those factors, the term “zeppelin” is preferred for use herein, but dirigible, blimp, and balloon also can be used.

Although “balloon” is not preferred for referring to elongated and steerable aircraft, it is valid and reasonable based on conventional usage in other fields, which define “balloon” to include nearly any type of flexible rubbery-type envelope that will expand when filled with a gas. Therefore, if lay-people, reporters, or others refer to elongated buoyant aircraft as balloons, that usage should be understood and tolerated, with gentle encouragement to use a better term.

Zeppelins in various shapes and sizes have been created, such as the Stratellite, which looks similar to a horizontally-flattened whale (illustrations can be found on the Internet, via Wikipedia or Google). That system is designed to fly in the upper atmosphere, roughly 15 miles high, to carry communication electronics. The flattened shape creates a larger upper surface for photovoltaic materials, which will be used to generate power for the electronics.

Zeppelins can be filled by either hydrogen or helium. Hydrogen gas is roughly 8% less dense than helium, for greater buoyant force, and it is less expensive; however, it is flammable and explosive. Since that is a hugely important factor, helium is preferred for buoyant aircraft.

However, if greatly increased numbers of buoyant aircraft are developed and used (such as for airplane lifting and takeoff systems) the vastly greater abundance of hydrogen (compared to helium) may drive the development of safe methods for using hydrogen, in such aircraft. The methods and approaches described below are not known to have been used in any prior art; accordingly, they are regarded as potentially patentable. However, since they are not the main focus of this invention, the art in those fields has not been searched, and these options are mentioned only in passing in this Background section.

For example, if helium and hydrogen are mixed together and then loaded into a single compartment (which can also be called a cell, chamber, etc.), the inert helium can reduce the flammability and explosive risk of the hydrogen. In addition, if hydrogen (or a hydrogen-helium mixture) is loaded into compartments positioned on the top side of a zeppelin, those compartments can be designed to burst open in an upward direction, if the hydrogen is ignited, without damaging lower compartments that are filled only with helium. This approach would be comparable to designing a munitions or chemical factory with a “blast wall” or ceiling made of thin and lightweight material that is designed to break or vent with little or no resistance, so that if an accident or explosion occurs, any damage will be minimized. Alternately, if hydrogen (or a hydrogen-helium mixture) is loaded into “inner” compartments surrounded by “outer” compartments filled with helium only, the layer of outer compartments can provide a surrounding protective layer, to reduce the risk of potentially breaching any of the enclosed and protected inner compartments.

In addition, since the aircraft discussed herein are designed to go through lifting cycles that require repeated inflation and deflation, any compartments that contain hydrogen (or a mixture of hydrogen and helium) can be designed to remain full at all times. Only the compartments that contain helium alone would be inflated and deflated, during the different stages of each lifting cycle. This would avoid subjecting any hydrogen to potentially dangerous pumping and handling operations.

Finally, if a zeppelin carries hydrogen in one or more cells, the hydrogen can be used as fuel, to provide power to any engines. For example, if an emergency requires a zeppelin to be uncoupled from a lifting ferry in mid-air, the zeppelin will need to be able to descend to a landing spot under its own power, presumably using a remote-controlled system that can be operated from the ground. This will require the use of propeller engines, which can be powered by burning hydrogen gas carried by the zeppelin.

In the 1980's, it was estimated that a large dirigible made of modern materials could lift 400 tons. However, those numbers may have been exaggerated by people more interested in marketing than science, as evidenced by the CargoLifter company of Germany, which raised hundreds of millions of dollars from investors. After taking that money from investors, CargoLifter went bankrupt, the money reportedly disappeared and was never found or accounted for, and a huge hanger that had been built, south of Berlin, was turned into an indoor theme park called Tropical Islands. Accordingly, all estimates for lifting capacity mentioned below have been scaled back to 300 tons, which is regarded as conservative and readily achievable. Indeed, since improved high-strength materials have been developed since the 1980's, it likely would be possible to exceed the 400-ton limit that was suggested in the 1980's.

Alternately or additionally, stacks and/or arrays of two, three, or more zeppelins can be coupled together, for greater lifting force, using high-strength cables (such as a set of three of more cable passing through the vertical center plane of a zeppelin, at spaced distances). In that approach, various internal frame components inside a zeppelin can be affixed directly to the cables, and the cables can pass cleanly and continuously, without any disconnects, through the lower zeppelin(s) in a stack. This would allow each zeppelin to exert its buoyant force on the cables, without imposing any distorting or other undesired stresses on the other zeppelins in a stack or array. If that approach is used, there is no upper limit to the amount of lifting force that can be generated. In addition, the risks of using potentially flammable hydrogen as the buoyant gas can be further reduced, by steps such as: (i) placing hydrogen in only the upper zeppelins, while the lower zeppelins contain helium only, and/or (ii) providing additional bladders that can be inflated, if an emergency occurs, by helium carried in high-pressure tanks.

Accordingly, one object of this invention is to disclose a method and machines for lifting airplanes high into the atmosphere, before they are released, in ways that will consume less fuel, and reduce emissions of carbon dioxide and other exhaust gases and pollution, compared to current airplane takeoffs.

Another object of this invention is to disclose methods, machines, and systems for slow and gentle lifting and takeoff of airplanes, in ways that create less noise, less mechanical stress, and greater safety than current airplane takeoffs, and that can create more interesting and enjoyable experiences for passengers.

Another object of this invention is to disclose an airplane takeoff system that uses a “lifting ferry” having at least four wings that can be rotated into a vertical position for lifting, and into a horizontal position for forward flight, in ways that will distribute the downward flow of high-speed air from propeller engines on the wings, so that the high-speed air will not directly blow against the wings of an aircraft that is being lifted.

Another object of this invention is to disclose an airplane takeoff system with a “lifting ferry” aircraft with rotatable wings, adapted for use with a gas-filled buoyant aircraft that can provide additional lifting force.

These and other objects of the invention will become more apparent through the following summary, drawings, and description.

### SUMMARY OF THE INVENTION

Lifting equipment, systems, and methods are disclosed which can enable airplanes to take off from the ground in a quieter, safer, and less expensive manner than current methods, with lower fuel consumption and reduced emissions of carbon dioxide and other exhaust gases. In one embodiment, a modified airplane called a “lifting ferry” is provided with at least four rotatable wings that can be turned vertical for high-efficiency lifting, and horizontal for flying and descent. At least two wings should be provided on each side of the fuselage, to provide engines around the periphery of an airplane being lifted, and to prevent the “downdraft” from large propeller engines (rather than jet engines) from blowing against the wings of the airplane being lifted. A set of heavy clamps, suspended beneath the lifting ferry, will be affixed to retractable lifting braces or brackets on the top of the airplane, for release of the airplane after a release height has been reached.

In an alternate embodiment, one or more helium-filled zeppelins can be coupled to the lifting ferry, by high-strength cables. In this embodiment, either the zeppelin or the ferry will contain high-pressure tanks and pumps, to partially deflate the zeppelin when the time approaches to release an airplane. Any such zeppelin preferably should have adjustable internal struts, to convert it into a streamlined shape (comparable to a fish) for moderate-speed flight and descent.

In a third embodiment, a zeppelin is modified by providing it with at least four engines around its periphery, affixed to axles or wings that allow the engines to be rotated between vertical and horizontal. This can effectively combine a lifting ferry and a zeppelin into a single unit.

### BRIEF DESCRIPTION OF THE DRAWINGS

FIG. 1 is a perspective view of a “lifting ferry” with a passenger jet suspended beneath it. The ferry is a modified airplane having four rotatable wings with propeller engines, around the periphery of the fuselage. A set of clamps at the ends of spacer bars allow the ferry to be secured to braces that are provided on the top of the jet.

FIG. 2 is a perspective view of a lifting ferry, showing a helium-filled zeppelin above the ferry unit. Those two units are not drawn to scale; in most cases, the zeppelin will be at least twice as long as the ferry.

FIG. 3 is a perspective view of a zeppelin with four rotatable engines around its periphery, which combines a lifting ferry and a zeppelin into a single unit.

### DETAILED DESCRIPTION

As summarized above, a system for lifting airplanes to flying altitudes uses a vertical-takeoff aircraft with rotatable wings. The vertical-takeoff aircraft is referred to herein as a “lifting ferry”, or simply as a ferry, to distinguish it from a conventional fixed-wing airplane that will be lifted to a flying altitude and then released.

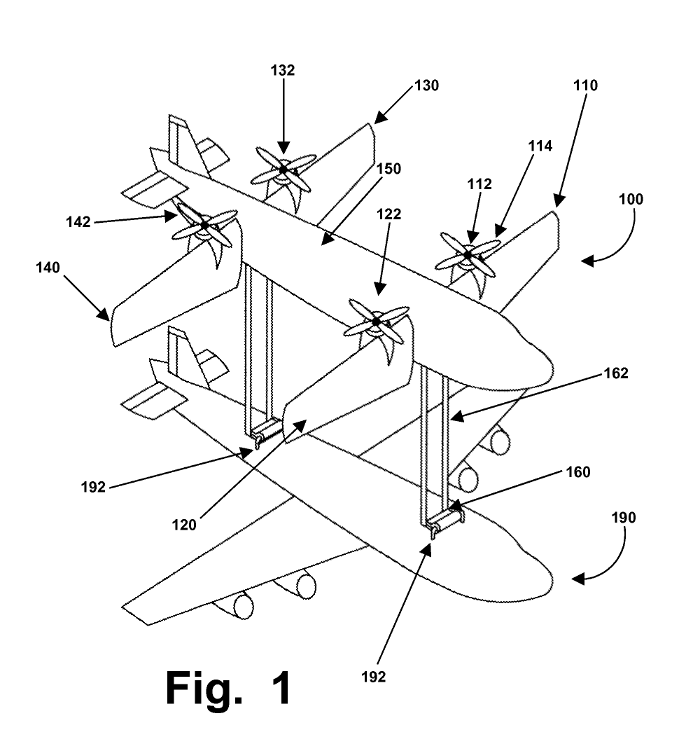

In one embodiment of this invention, illustrated in FIG. 1, lifting ferry 100 is being used to lift a fixed-wing passenger jet 190. The lifting ferry 100 has two front rotatable wings 110 and 120, and two rear rotatable wings 130 and 140, with at least one engine 112, 122, 132, and 142 mounted on each wing. The rotatable wings 110-140 will be designed in a manner comparable to the wings of vertical takeoff aircraft, such as the Osprey and Harrier airplanes developed for U.S. and British military forces.

Instead of being able to rotate through an entire circle, the rotatable wings only need to rotate through a 90 degree arc, from a “vertical upward” position to a “forward horizontal” position. Accordingly, the term “rotatable” as used herein does not require complete rotation around a full circle, and instead can apply to mounting means that allow only partial rotation.

Preferably, at least one front wing and one rear wing should be mounted on each side of ferry body (fuselage) 150. A sufficient distance should be provided between the front and rear wings, on each side of ferry 100, to accomplish four objectives: (1) to provide distributed and stable lifting forces around the periphery of the ferry and airplane, during a lifting operation; (2) to enable any combination of engines to have their speeds increased or decreased, if needed, to correct for any tilting; (3) to provide enough reserve power to prevent a crash, even if one engine fails; and, (4) to position the ferry engines far enough apart so that high-speed air from the propellers (often called propwash) will not blow directly against the wings of airplane 190, in ways that would seriously impair lifting efficiency, or that would impose undue stress on the airplane wings.

Propeller rather than jet engines are preferred for ferry 100, for several reasons, including greater fuel efficiency and improved hovering performance, and to prevent hot exhaust gases from jet engines from damaging or endangering people, airplanes, runway or tarmac surfaces, or buildings on the ground. The need to avoid hot exhaust gases from jet engines is important, since a lifting ferry will need to hover at low altitude when the ferry is being coupled to an airplane sitting on the ground. In addition, as a lifting ferry approaches a plane-release altitude high in the air, its wings will be rotated from vertical (for lifting) to horizontal (to establish forward flight). During that wing rotation, air or exhaust from the engines on the front wings of ferry 100 will blow directly toward the wings of airplane 190 for some period of time, and hot exhaust from jet engines could damage those wings.

Oversized propellers (sized at a midpoint between airplane propellers, and helicopter rotors) can be used for the ferry engines. If desired, the propeller blades can be provided with pitch control, using known mechanisms. The number of blades on each propeller can range from two to eight, with four to six blades as a preferred range for most uses. If desired, two or more engines can be provided on any or all of the wings. If the edges of two propellers on the same wing approach each other, those propellers can operate in opposite directions (one clockwise, and one counter-clockwise), to avoid excessive shear forces or turbulence in the gaps between the blade tips. If desired, the propellers on rear wings 130 and 140 can be positioned at “offset” vertical and/or horizontal spacings, compared to the propellers on front wings 110 and 120, by means such as (i) mounting front and rear engines at different distances from the fuselage, and/or (ii) mounting the front and rear wings on two different “wing axles” that pass horizontally, at different heights, through fuselage 150.

The body (or fuselage) 150 of lifting ferry 100 should be streamlined for forward flight, but it does not need to be fully cylindrical or enclosed in the normal manner used for passenger or cargo airplanes. If desired, it can have a shape comparable to the bodies of cargo-lifting helicopters (such as a Sikorsky Skycrane or Erickson Air-Crane), which have vacancies in their body shape to allow them to “nestle down” more snugly on a rectangular shipping container or other item that will be lifted.

However, for safety and operating purposes, and to avoid creating dangerously high propwash speeds on the ground during the coupling stages, a substantial vertical distance (which likely will range from about 50 to 500 feet, or about 15 to 150 meters) should be provided between lifting ferry 100 and airplane 100.

Accordingly, lifting ferry 100 is provided with a series of large and strong clamps 160 (or similar affixing devices), positioned at the bottom ends of spacer poles (or bars, struts, etc.) 162, at a series of locations on the underside of fuselage 150. When clamped shut, clamps 160 will allow airplane 190 to be suspended beneath, and lifted by, ferry 100.

Spacer poles 162 should have substantial but not rigid stiffness, and should be affixed to ferry 100 using resilient, motion-damping, spring-type and/or shock absorber attachment devices, which preferably should act both longitudinally (i.e., allowing slight variations in the lengths of poles 162) as well as rotationally (i.e., where poles 162 enter or approach fuselage 150). This can allow various types of lateral, vertical, or other forces or motions to be distributed and dissipated between ferry 100 and airplane 190 in a non-jarring, nondamaging manner. Spacer poles must be provided with means for retraction and/or rotation into a horizontal trailing position, to prevent interference with landing of the ferry 100.

Unless modeling or tests indicate otherwise, cables preferably should not be used to suspend airplane 190 beneath ferry 100. If turbulence in the upper atmosphere (which is common) causes airplane 190 to momentarily rise up closer to ferry 100, leading to momentary slackening of any cables that suspend the airplane beneath the ferry, the slack cables can create dangerous or destructive jarring, jerking, or hammering forces when they “snap tight” again. In mechanical terms, cables would create too many degrees of freedom, which would jeopardize and impair control of the system.

To render any airplane suited for lifting by this method, it will need to be provided with lifting braces 192 (or similar components) which can be securely gripped by ferry clamps 160. Any lifting braces on an airplane preferably should be retractable and/or hinged, to minimize “drag” on airplane 190 after it has been released from ferry 100.

When a lifting operation is ready to begin, rotatable wings 110-140 on ferry 100 will be rotated into vertical position, as shown in FIG. 1, for maximum lifting force and efficiency. This will place the propeller blades (such as blades 114, shown on engine 112) in a horizontal rotation mode, comparable to a helicopter rotor. Ferry 100 will be flown into a hovering position directly over an airplane on the ground, which is loaded with passengers and/or cargo, and ready to take off. The lifting ferry 100 will hover above the airplane for a minute or so while the clamps 160 are secured to the braces 192 on airplane 190.

If desired, the clamping and securing operation can be assisted by cables controlled by power winches, under the control of someone who is watching and monitoring (either directly, or by means of a video monitor) the proximity of clamps 160 relative to lifting braces 192, as ferry 100 moves into position above airplane 190. Such cables also can be used to provide greater safety and security during the initial stages of a lifting operation. For example, when the engines and propellers on ferry 100 are revved up to lifting speed, they should be able to exert predetermined amounts of tension (measured in tons or metric tons) on the securing cables affixed to ferry 100. Accordingly, the guide and securing cables also can be used to confirm that proper amounts of lift are being generated, before ferry 100 is allowed to begin lifting airplane 190 off the ground.

When ferry clamps 160 have been secured to airplane braces 192, ferry engines 112, 122, 132, and 142 will be “revved up” (i.e., accelerated, to increase the speed of the propellers, measured in revolutions per minute, rpm) until the propellers generate enough lifting thrust to lift ferry 100 and airplane 190 off the ground. Ferry 100 will begin rising vertically, like a helicopter, with airplane 190 suspended beneath it.

If guiding cables (attached to the bottom of ferry 100, and secured to powered winches on the ground) were used to help guide and stabilize the ferry while clamps 160 were moved into position to grip braces 192 on airplane 190, those same cables, still attached to the winches and to the ferry, can be used to secure and stabilize the ferry-and-airplane assembly as it initially rises above the ground. The cables can be used as securing means until the ferry-and-airplane assembly reaches an initial checking height (for example, when the bottom of the airplane has risen 15 to 100 meters above the ground). After the ferry-and-plane system completes any tests to confirm performance, stability, and security, the cable attachment devices in the ferry can be detached and released, using spring-loaded, pressurized gas, or other mechanisms to toss the cable ends (and any attachment devices) outward, a safe distance away from airplane 300.

Ferry 100 and airplane 300 will rise through the air, lifted vertically by the ferry. When they approach a suitable altitude for releasing the airplane (which in most cases will range from 5,000 to 35,000 feet), the airplane engines will be started up; alternately, if the airplane engines were idling at low speed during lifting, they will be revved up to flying speed. This will exert forward thrust on the entire assembly, which will begin moving forward horizontally. Since the thrust from the airplane will be exerted at a height that is below the “centroid” (which effectively is the center of gravity of the assembly), that forward thrust will need to be controlled. There are several ways of doing that, in ways that will prevent the entire assembly from going into a “roll” maneuver”, such as a combination of: (i) keeping the speed and thrust of the airplane engines throttled back, until the airplane is released or immediately before release; (ii) commencing partial rotation of the ferry wings, from their vertical lifting position, into a forward flying position; and, (ii) using the wing flaps on ferry 100 and airplane 190 to maintain a horizontal or ascending flight path. These can be accomplished by pilots who have learned to fly such systems, using the types of computerized simulators used to train military and commercial pilots.

As the assembly begins to move forward, at least two and possibly all four of the wings 110-140 on ferry 100 will be rotated partially and then more extensively into a horizontal direction, which will increase flying speed. When the speed of the assembly exceeds the stall speed of airplane 190, clamps 160 will be opened, thereby releasing airplane 190, which will fly independently to its destination.

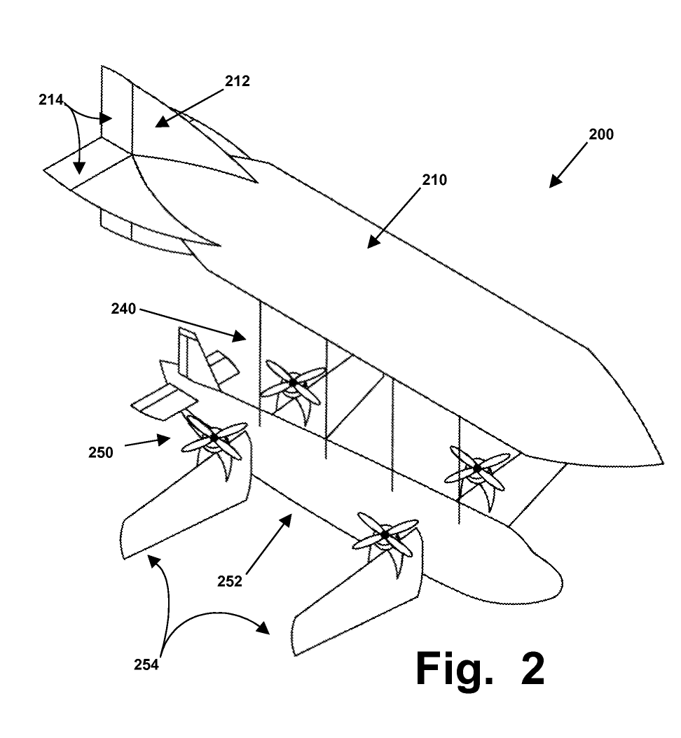

Alternately, if ferry 100 and airplane 190 are angled downward at the moment of release, airplane 190 will begin falling and gliding forward, after release, in a “glide path”. That downward gliding motion, driven by gravity, will increase the speed of airplane 190. When the forward speed of airplane 190 surpasses its stall speed, the airplane can level off and fly normally. This type of downward-angled release can enable an airplane to be released by a ferry at essentially any forward velocity, regardless of whether that velocity exceeds the stall speed of the airplane, so long as the airplane is angled downward in a manner that will establish a glide path at the moment of release. This type of maneuver is not crucial, if ferry 100 is not suspended beneath a zeppelin, since ferry 100 can fly at a speed that exceeds the stall speed of airplane 190. However, if a zeppelin is used to provide additional lifting force, as described below and as illustrated in FIG. 2, the option of using a downward release angle to create a sloped glide path can be useful, for releasing airplane 190 at a relatively slow speed.

After release of airplane 190, ferry 100 will be fully capable of controlled forward flight on its own. It will descend and return to its airport, to prepare it for lifting another airplane. During descent, only minimal power will be needed, and either the front or rear engines can be turned off or run at idling speeds.

Accordingly, even without a zeppelin or other buoyant aircraft, a lifting system that uses propellers rather than jet engines, and that provides direct upward thrust (rather than having to generate indirect lifting force as a byproduct of horizontal wing motion) can be substantially more fuel-efficient than conventional airplane takeoffs. It can also provide other benefits, including quieter takeoffs, reduced stresses on airplanes, etc. Lifting ferries can be designed and built in different sizes to lift various types and sizes of airplanes, so long as any such airplane is provided with accommodating lifting braces. Such ferries can lift airplanes to any desired flying heights, such as up to 35,000 feet, which is standard cruising altitude for most commercial jets.

The next section describes a more complex embodiment, which can be rendered substantially more fuel-efficient by adding a buoyant aircraft, such as a zeppelin, to the system.

Ferry System With Buoyant Lifting

As mentioned in the Background section, the terms blimps, dirigibles, zeppelins, and balloons can be used interchangeably to refer to the types of elongated, steerable, gas-filled buoyant aircraft of interest herein. For reasons stated above, zeppelin is preferred herein.

Lifting system 200 shown in FIG. 2 comprises zeppelin 210, coupled via cables or bars 240 to lifting ferry 250. Ferry 250 (which has fuselage 252 and rotatable wings 254) is essentially identical to ferry 100 as shown in FIG. 1, except that fuselage 252 of ferry 250 must be provided with an internal reinforcing frame that can distribute and withstand large lifting forces along the length of fuselage 252.

Lifting assembly 200 is designed to lift a fixed-wing airplane (not shown), suspended beneath ferry 250 by the same types of lifting clamps and spacer bars shown in FIG. 1 (those are not shown in FIG. 2, to avoid clutter). After the lifting assembly 200 reaches a release height, the airplane will be released so it can fly to its destination, while the lifting assembly 200 will return to its originating airport (or to a nearby airport, if a shuttle system is shared by two airports).

In one embodiment, lifting ferry 250 is coupled to zeppelin 210 by high-strength cables 240, which are spaced horizontally to distribute the lifting force of zeppelin 210 across multiple components of an internal frame or reinforcing component, inside ferry 250. Any cables or other tension-bearing members used herein can be made of materials with high strength-to-weight ratios, such as polyaramids (sold as KEVLAR™ by DuPont), buckytubes (also called carbon nanotubes), fiber-reinforced graphite, etc.

Alternately, to provide greater control, cables 240 can be replaced by semi-stiff poles or struts, to reduce the risk of jerking or jarring stresses that might occur among cables, if turbulence during flight causes a cable to go slack and then be jerked taut (as discussed above in relation to spacer poles 162). The risk of turbulent jerking will be lower, when a zeppelin is coupled to a ferry, compared to a ferry coupled to an airplane, and in most cases, such risks likely can be handled adequately by incorporating strong springs, shock absorbers, or similar devices in the cable attachment devices that are mounted in zeppelin 210 and ferry 250. Nevertheless, since safety measures must be designed to accommodate “worst case” rather than “most case” scenarios, a presumption arises that bars, poles, pipes, struts, etc., are preferred over flexible cables for use as tension-bearing coupling members 240, and that any such bars, poles, pipes, struts, etc. should be provided with spring-loaded and motion-damping mechanisms, to absorb and dissipate any jarring or jerking motions that might be caused by turbulence.

Zeppelin 210, shown in FIG. 2, is not drawn to scale. Most commercial jets range from about 150 to 230 feet in length; as examples, a Boeing 747 “jumbo jet” is 230 feet long, a Boeing 787 is 186 feet long, and different models of Boeing 767 jets range from 150 to 180 feet. By contrast, zeppelins have been made with lengths greater than 800 feet. Accordingly, the zeppelin is likely to have a length at least twice as long as the ferry.

As mentioned above, it was estimated in the 1980's that a large helium-filled zeppelin could lift a payload of about 400 tons (800,000 pounds, which is roughly 360 metric tonnes). That is more than twice the maximum takeoff weight of a fully-loaded Boeing 787, which is 360,000 pounds (180 tons). Accordingly, when zeppelins are used for the purposes described herein, they will not need to be exceptionally large, and are likely to range in most cases from about 200 to about 700 feet long (i.e., about 60 to 200 meters).

However, at the long end of the range, it should be noted that maximum takeoff weight is a crucially important limit for any airplane. Since that limit will be drastically altered by the lifting systems disclosed herein, it will become feasible to design heavier airplanes that can carry more passengers and/or cargo per flight (which can increase fuel efficiency, reduce ticket costs, etc.). Accordingly, larger and longer zeppelins may be preferred for lifting very large airplanes that may evolve in response to the development of lifting ferries (and for lifting modified versions of “super-jumbo” jets, such as the Airbus 380 which currently is facing serious problems and extended delays, due at least in part to the huge challenges of building an enormous jet that must be able to take off in the normal manner from conventional runways).

It also should be noted that a vertical “stack” of two, three, or even more zeppelins can be created, without imposing any major stresses on the lower zeppelins, by using cables that pass continuously through the vertical longitudinal center plane of any “lower” zeppelin. If the internal frame of a lower zeppelin in a stack is securely clamped or otherwise affixed to a row of high-strength cables that pass cleanly and continuously through the longitudinal center of the lower zeppelin, any upper zeppelin(s) will exert their lifting forces on the cables, rather than on vulnerable frame or envelope components of the lower zeppelin(s).

Similarly, an entire array of zeppelins can be created and used, if desired, by vertically stacking two or more horizontal or semi-horizontal rows, with two or three zeppelins in each row. However, while that approach is suited for lifting large and very heavy rockets loaded with fuel, as described in U.S. Pat. No. 7,131,613 (cited above, as the parent application herein), it should not be necessary for lifting airplanes, which are lighter.

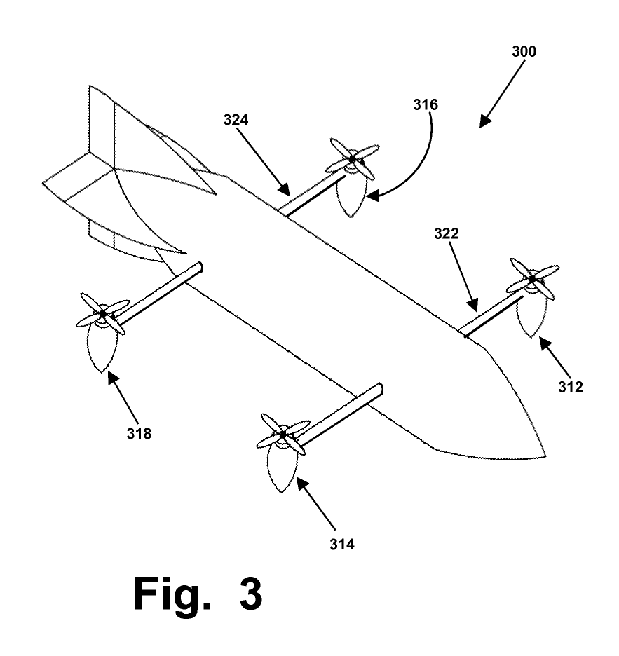

Also, any zeppelin used in a lifting system as disclosed herein will be used in combination with propeller engines, mounted either on a lifting ferry (as shown in FIG. 2) or on the zeppelin (as described below and shown in FIG. 3). Accordingly, the buoyancy provided by a zeppelin will not need to lift the entire weight of an airplane.

As the assembly approaches an altitude referred to herein as the release height (or altitude), the airplane will start its engines (or if its engines were idling during the lifting stage, it will rev up the engines, to generate higher levels of forward thrust). This will cause the airplane to begin towing the entire system forward, at a speed that will be limited by the lifting ferry and zeppelin(s). As the wings of the airplane begin to generate their own lift, two or more of the wings 254 of ferry 250 will be rotated partially forward, generating additional forward thrust and speed.

As that process begins and the assembly begins to pick up speed, a portion of the helium is pumped out of zeppelin 210, in a manner that leads to controlled deflation. Deflation preferably should lead to controlled flattening and streamlining of the outer shape of the zeppelin, in a manner that creates a dominant axis, either vertically (comparable to most types of fish) or horizontally (comparable to a manta ray). This modified shape can be created by extending one set of internal “spines” (or struts, rods, etc.) inside the zeppelin (such as a set of vertical spines), while shortening the spines in the other direction (such as the horizontal spines). These types of synchronized elongating and shortening operations can be carried out by various mechanisms, such as by using electric motors to: (i) rotate threaded shafts within sleeves or nuts; (ii) rotate gears that will drive rack-and-pinion or chain-and-sprocket gears; or, (iii) drive fluid pumps that will lengthen or shorten piston-and-cylinder systems. Alternately or additionally, rotatable hinged frame components also can be used to create a streamlined external shape during deflation.

In order to proceed with sufficient speed, the deflation pumps (these usually are called compressors, when gases are being pumped) should use multiple “heads” (i.e., the gas-handling devices, each of which will have at least one intake opening, a set of rotating fanblades, reciprocating pistons, or similar devices, and an outlet channel coupled to a pressurized pipe or other conduit) mounted on a limited number of driveshafts. This can reduce the “overhead” costs (which includes weight, in this context) of providing multiple fuel-burning or electric motors, to drive the driveshafts.

To further accelerate deflation, additional steps also can be taken, if desired. As one example, a powered rotatable shaft can be provided with thin, strong fibers wrapped around it, in a manner comparable to a spool or winch. The other ends of the fibers can be coupled to securing points that are distributed across a large membrane that forms one wall of a gas compartment (or chamber, cell, etc.). As the shaft is rotated, the fibers wrapped around the shaft will pull the membrane closer to the shaft. This will increase the pressure and density of the gas in that compartment, not by a large multiple, but by a potentially significant degree.

Any other currently-known or hereafter-discovered machine or method for increasing the efficiency of handling the helium or hydrogen gas, during either the pumping/compression stage or the expansion stage, can be evaluated for use as described herein.

As one example, the Applicant is aware of an air-pumping system that was being evaluated at the Arthur D. Little consulting firm, in Cambridge, Mass., in 1981 and 1982, which asserted was more efficient that any other gas pumping system those consultants had ever seen. Although it was being evaluated at that time mainly for use in automobile air conditioners, it may merit attention. Briefly, it used two sets of plates, each having a generally spiral-shaped ridge or wall that rose roughly ¼ inch above the surface of the plate. A movable plate was pressed against a stationary plate, so that the two sets of spiral ridges engaged each other, and fit together. The movable plate was then moved in a manner that is usually referred to as “orbital” (i.e., instead of rotating the movable plate around a center axis, its edges were held in their same orientation while the plate moved in a circular manner, as one might do with a piece of hand-held sandpaper). This caused a set of arc-shaped gaps, between the stationary and movable ridges or wall surfaces, to be formed, and moved. The relative motion of the two plates drove and pushed those arc-shaped pockets of gas toward the center of the plates (one of which was provided with an outlet), when motion continued in one direction, or toward the peripheral rim of the plates, if the motion was reversed.

While the Applicant does not know the fate of that type of compressor or pumping system, he recalls it being appraised as a very efficient gas-handling system. Accordingly, it offers one example of a candidate type of compressor or pump that merits evaluation for use as disclosed herein. In some respects, that “two-plate” pump or compressor is analogous to a “Wankel” internal combustion engine, which uses a generally triangular device that rotates around an enlarged center axis, within a chamber having a “FIG. 8” configuration. Conventional piston engines must use and consume (and therefore waste) a substantial portion of their potential work output, forcing their pistons to change direction and momentum thousands of times per minute, at very high speeds. By contrast, since a Wankel “piston” always rotates in a single direction, that amount of energy can be conserved and used, as work output. In a similar manner, the two-plate gas pump or compressor mentioned above has certain advantages over both (i) reciprocating compressor pistons, and (ii) spinning compressor blades. When reciprocating compressor pistons are used, the pistons must reverse direction and momentum, twice during each and every stroke, which consumes and wastes energy. When spinning compressor blades are used, the high pressures they create work against the system, by forcing molecules of gas back through the fan blades in an unwanted counter-flow direction, reducing the efficiency of the compressor. Since both types of inherent inefficiencies can be avoided and overcome by two-plate compressor units as described above, they have the potential for higher efficiency, and merit evaluation.

In a similar manner, various pumping or compression mechanisms and methods can be evaluated for use in two-stage or three-stage compression. In the first stage, a gas can be compressed from low pressure to moderate pressure; in the second stage, the gas can be compressed from moderate pressure to high pressure. For various reasons, two- or three-stage compression can be more efficient than single-stage compression.

By using using controlled deflation, and a controllable zeppelin frame designed to create a streamlined shape as deflation occurs, a partially-deflated and streamlined zeppelin can be towed forward through the upper atmosphere at a substantial speed, even while it continues to exert substantial lifting force. During the transition from the vertical lifting stage to forward flight, the lift generated by the airplane and ferry wings will compensate for the loss of buoyancy as the zeppelin is partially deflated.

As mentioned above, a lifting system that uses a ferry but not a zeppelin can be designed to fly forward at speeds greater than the “stall speed” of an airplane (the velocities that affect stall speeds and wing lift are measured relative to surrounding air and winds, rather than relative to the ground). That will allow an airplane to be released safely in a completely horizontal direction. However, if a zeppelin is used in a lifting assembly, it likely will not be possible for the assembly to exceed the stall speed of the airplane, since the ferry and airplane will be slowed down by the zeppelin. Therefore, as mentioned above, an airplane can be angled downward at the moment of release, to create a downward “glide path” for the airplane. As the plane glides forward, its speed will increase, due to gravity and to the thrust of its engines. Once the airplane exceeds its stall speed, it can level off and fly normally.

After release of the airplane, deflation of zeppelin will continue until lifting assembly 200 reaches or approaches a slightly negative buoyancy (alternately, if the wings of the ferry are rotated beyond the horizontal plane, causing them to point downward, the engines can be used to effectively pull down the system; this can reduce the amount of power that must be used to compress the gas in the zeppelin during each cycle). Assembly 200 will descend to a landing site (or, it may move directly into position, hovering over another airplane that is ready for takeoff), presumably at or near its originating airport, to prepare for another lifting cycle.

During normal operations, ferry 250 will remain coupled to (and suspended beneath) zeppelin 210 throughout each lifting cycle. However, if an emergency occurs, ferry 250 can release and/or forcibly eject the devices that are used to couple the lower ends of cables 240 to ferry 250. This will allow ferry 250 to detach from zeppelin 210 and fly separately, either on its own if it has already released airplane 290, or while continuing to carry the airplane it is lifting, until those two units reach a stable position at an altitude that will allow the airplane to be released. Accordingly, the reduce the risk of disaster in such emergencies, ferry 250 should be provided with engines that can generate enough total thrust to lift any airplane it will carry. If desired, this can involve backup or reserve engines that are never used except in an emergency.

To enable emergency detachment of zeppelin 210, the zeppelin should carry a sufficient number of high-pressure pumps and tanks to enable deflation of the zeppelin to a point of slightly negative buoyancy, which will cause the zeppelin to descend on its own. To enable control over such a descent, zeppelin 210 should be provided with vertical and horizontal tail fins 212 with movable flaps 214, and a set of propeller engines (such as engines 312-318, as shown in FIG. 3). If one or more gas compartments in zeppelin 210 contain hydrogen, the hydrogen can be used as fuel to provide power for the engines. At least some of the engines preferably should be mounted on axles (such as axles 322-328, shown in FIG. 3) or other coupling devices, to allow the engines to be rotated when desired, in ways that can generate varying combinations of upward, downward, forward, reverse, and lateral thrust that may be needed during descent and landing.

For safety purposes (such as to prevent accidents, if a gust of wind pushes a zeppelin in an unwanted direction during a landing operation), the propellers on engines 216 preferably should be surrounded by generally cylindrical cowls. Any engines 216 should be affixed to strong internal frame components of a zeppelin, in ways that will not impose any stresses on the outer skin of the zeppelin. Preferably, all engines, engine mounting axles, and fins on zeppelin 210 should be remotely controllable, so zeppelin 210 can be landed safely using a ground control system.

If zeppelin 210 is detached from ferry 250, the cables that coupled them together presumably will hang down from the zeppelin, after detachment. Those cables can be used for securing zeppelin 210, when it approaches the ground. The ends of the cables can be initially secured by grappling devices mounted on trucks, carts, etc.; after a grappling operation has been completed, the cables can be secured to power winches. If an emergency requires zeppelin 210 to be detached from ferry 250, a presumption will arise that the zeppelin 210 should be landed in an unpopulated area, away from any airports, cities, etc., while ferry 250 will be cleared for an emergency landing at any suitable landing spot (which will not require a full runway, due to its rotatable wings).

By using such systems, fuel consumption and carbon dioxide emissions during airplane takeoffs can be substantially reduced. Takeoffs can be quieter and safer, and the slow lifting process can become an enjoyable part of a flying experience, especially if the windows of an airplane are enlarged to provide passengers with better views as they are lifted into the sky.

Modified Zeppelin With Rotatable Engines

Another preferred embodiment, illustrated in FIG. 3, comprises a modified zeppelin 300 having at least four propeller engines 312-318, mounted on a set of rotatable axles 322 and 324. Engines 312-318 preferably should be mounted near the front and read ends of zeppelin 300, on both sides of the craft, to provide lifting forces that are distributed around the periphery of the zeppelin 300. This can provide balanced and distributed lifting points, and the speed of any of the engines can be increased or decreased, to compensate for and minimize any unwanted tilting. Additional engines can be provided, such as by placing two or more engines on an axle, or by providing additional axles at spaced locations along the length of zeppelin 300 (although any such axles and engines should not be mounted directly above the wings of an airplane that is being lifted).

If desired, front axle 322 and rear axle 324 can each be a continuous axle that passes horizontally through the zeppelin; alternately, the axle components that support each of the four engines can be independently controllable. Similarly, instead of providing axle supports than can rotate, engine support components 322 and 324 can be non-rotating pipes, bars, girders, etc., and the engines can be mounted at or near the ends of those non-rotating supports, using mounting means that enable rotation. Any such axles or other supports should be coupled to strong internal frame components within the zeppelin, so that no significant stresses will be placed on the outer skin of the zeppelin.

The propellers on all the engines preferably should be surrounded by generally cylindrical cowls, to minimize the risk that any cables or other components might become ensnared by the propellers. Whenever propellers rotate at high speed, they create a suction effect in front of the propellers, which creates a risk that anything movable which approaches a propeller can be pulled into the propeller. That risk can be minimized by a cowl device around the propeller, and the cowl entry can be protected if desired by a grid-type device, comparable to an enlarged screen or mesh, but formed by thin strips of metal or similar material that are aligned in a way that will not block the flow of air through the grid.

Zeppelin 300 carries its own set of high-pressure pumps and tanks, for partially deflating the zeppelin. Those pumps and tanks are not shown in FIG. 3, since they will be contained within the streamlined outer envelope of zeppelin 300. Those pumps and tanks will be used to partially deflate the zeppelin after it has reached a desired altitude, either shortly before or shortly after the airplane is released from the zeppelin.

Thus, there has been shown and described a new and useful means for lifting airplanes or rockets up to flying altitudes, in an energy-efficient manner. Although this invention has been exemplified for purposes of illustration and description by reference to certain specific embodiments, it will be apparent to those skilled in the art that various modifications, alterations, and equivalents of the illustrated examples are possible. Any such changes which derive directly from the teachings herein, and which do not depart from the spirit and scope of the invention, are deemed to be covered by this invention.

1. A rotatable-winged aircraft, comprises:
a. a fuselage;
b. at least one rotatable forward wing, and at least one rotatable rear wing, on each side of the fuselage;
c. at least one engine mounted on each of said rotatable wings; and,
d. means for reversibly coupling said rotatable-winged aircraft to a fixed-wing airplane, in a manner that enables said rotatable-winged aircraft to lift said fixed-wing airplane to a flying altitude and then release said fixed-wing airplane from said rotatable-winged aircraft.

2. The rotatable-winged aircraft of claim 1, wherein said forward and rear rotatable wings on each side of said fuselage are positioned apart from each other a sufficient distance to prevent downflow of high-speed air or gases from said engines mounted on said rotatable wings from blowing directly against the wings of an airplane being lifted by the rotatable-winged aircraft.

3. The rotatable-winged aircraft of claim 1, wherein said means for reversibly coupling said rotatable-winged aircraft to a fixed-wing airplane comprises a plurality of clamps at spaced locations beneath the fuselage, wherein said clamps have sufficient strength to lift an airplane during a lifting operation.

4. The rotatable-winged aircraft of claim 1, wherein all of said engines mounted on said rotatable wings are propeller engines.

5. The rotatable-winged aircraft of claim 1, which also comprises mounting attachments that enable said aircraft to be suspended beneath and lifted by a gas-filled buoyant aircraft.

6. A lifting system for vertical lifting of fixed-wing airplanes into the air, comprising:
a. a rotatable-winged aircraft comprising a fuselage, at least one rotatable forward wing, and at least one rotatable rear wing on each side of said fuselage, and at least one engine mounted on each of said rotatable wings;
b. at least one gas-filled buoyant aircraft; and,
c. means for suspending said rotatable-winged aircraft beneath at least one gas-filled buoyant aircraft.

7. The lifting system of claim 6, which also comprises means for reversibly coupling said rotatable-winged aircraft to a fixed-wing airplane, in a manner that enables said lifting system to lift said fixed-wing airplane to a flying altitude and then release said fixed-wing airplane from said lifting system.

8. The lifting system of claim 6, wherein at least one buoyant aircraft comprises at least four propeller engines, mounted at spaced locations around said buoyant aircraft.

9. The lifting system of claim 8, wherein said propeller engines are mounted on said buoyant aircraft in a manner that enables said engines to be rotated between vertical and horizontal directions.
